(19) United States
(12) Patent Application Publication
(10) Pub. No.: US 2008/0256579 A1
(43) Pub. Date: Oct. 16, 2008

(54) Assisted User Control in Recommenders

(75) Inventors: Johannes Wilhelmus Franciscus Verhaegh, Heusden Gem Asten (NL); Srinivas Gutta, Bangalore (IN); Serverius Petrus Paulus Pronk, Vught (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/914,027

(22) PCT Filed: May 9, 2005
(86) PCT No.: PCT/IB2005/051509

§ 371 Date: Nov. 9, 2007

Related U.S. Application Data
(60) Provisional application No. 60/647,334, filed on Jan. 26, 2005.
(60) Provisional application No. 60/557,221, filed on Mar. 29, 2004.

(51) Int. Cl. G06F 3/00

(52) U.S. Cl. 725/46

(57) ABSTRACT

A method and arrangement for modifying settings of a television program recommender (200) displays the rating (recommended or not recommended) for a selected television program, and also displays profile parameters of the user in a bar graph-type display in which the value of the profile parameters in each of a plurality of categories are shown as the positions of profile parameter icons (302-308), while the television program recommender further shows icons (312-318) representing threshold levels in each category above which the selected television program would be recommended. The user is enabled to change the values of the profile parameters in at least one of the categories by moving the relevant profile parameter icon (302-308) such that, for example, it reaches, or passes, the respective threshold level icon (312-318). The television program recommender (200) then recalculates the rating and the threshold levels to correspond with the desires of the user. As such, the user is able to modify the profile parameters of the television program recommender (200) such that it recommends, or does not recommend, programs in accordance with the desires of the user.

The subject invention relates to recommenders for recommending programs for viewing by a user.

In recommender technology, often a distinction is made between explicit and implicit recommenders. In an explicit recommender, a user explicitly inputs his/her preferences for different categories of content. For instance, he/she can indicate that he/she likes action movies very much by giving the genre “action move” a high score, and that he/she dislikes a particular channel by giving it a low (or negative) score. Then, for a new program, the scores of the categories are combined to determine a recommendation score. In an implicit recommender, the user does not give the feature scores him/herself, but rather, a learning system is used that derives them from training examples (programs that the user has liked or disliked).

The main advantage of an explicit recommender is that the user is in full control. The main advantage of an implicit recommender is that the system is easy to use.

While an explicit recommender puts the user in full control, it is not particularly clear to the user how changing ratings for the different categories eventually affects which programs are recommended and which ones are not. For instance, if a certain TV show is not recommended, it is not clear which attributes should get a higher rating and how much higher it should be, in order for the show to become recommended.

It is an object of the invention to give a user assistance in setting the attributes' ratings in both an explicit recommender and an implicit recommender.

This object is achieved in a method for controlling a program recommender, comprising the steps of:

generating and storing profile parameters in various categories concerning a user's likes and dislikes in programming; calculating a rating for a selected program based on said profile parameters in said various categories; determining whether or not said selected program is recommended; calculating a threshold score in each of said various categories above which said selected program would be recommended; displaying whether or not said selected program is recommended, said profile parameters and said threshold scores; enabling said user to adjust at least one of said profile parameters with respect to a respective at least one of said threshold scores in order to change whether said selected program and other similar programs are or are not recommended; and recalculating said rating and said threshold scores in accordance with said at least one adjusted profile parameter.

This object is further achieved in an arrangement for controlling a program recommender, comprising means for generating and storing profile parameters in various categories concerning a user's likes and dislikes in programming; means for calculating a rating for a selected program based on said profile parameter in each of said various categories; means for determining whether or not said selected program is recommended; means for calculating a threshold score in each of said various categories above which said selected program would be recommended; means for displaying whether or not said selected program is recommended, said profile parameters and said threshold scores; means for enabling said user to adjust at least one of said profile parameters with respect to a respective at least one of said threshold scores in order to change whether said selected program and other similar programs are or are not recommended; and means for recalculating said rating and said threshold scores in accordance with said at least one adjusted profile parameter.

As such, the user is able to directly adjust the stored profile parameters in an intuitive manner such that the desired results are obtained, i.e., that a particular show and similar shows are or are not recommended.

In a particular embodiment, said profile parameters and said threshold scores are displayed as respective icons on a bar chart-type graph, wherein the profile parameter icons are moveable by said user, the movement of the profile parameter icons representing new values for said profile parameters.

As such, by moving particular ones of the profile parameter icons, the user is able to directly affect the rating of a particular show and similar shows.

With the above and additional objects and advantages in mind as will hereinafter appear, the invention will be described with reference to the accompanying drawings, in which:

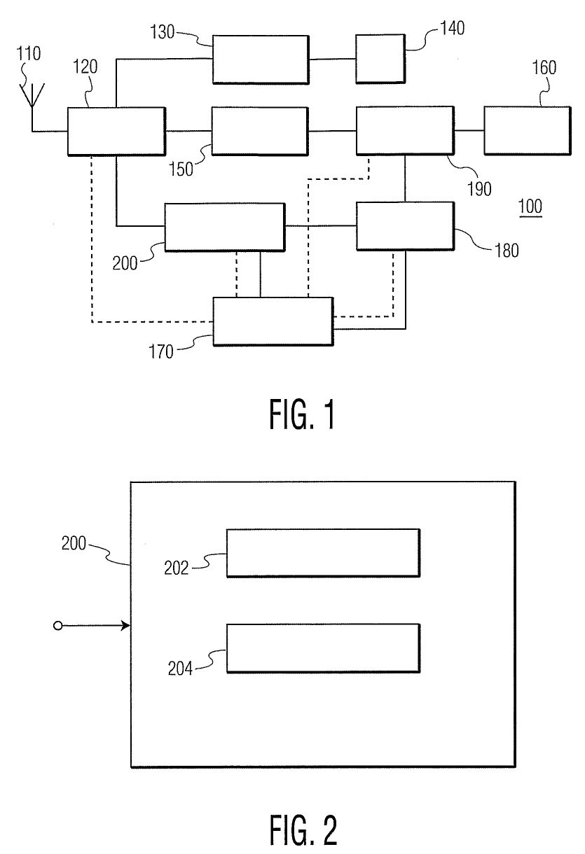

FIG. 1 is a block schematic diagram of a television receiver incorporating the invention;

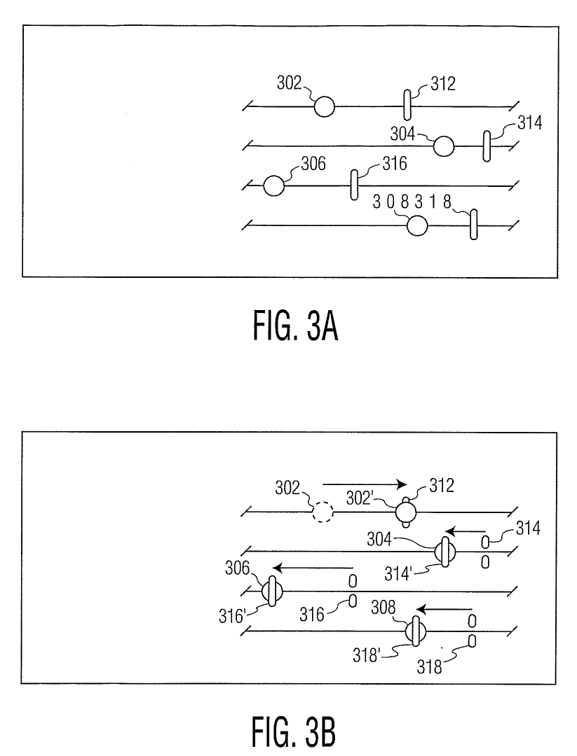

FIG. 2 is a block diagram of a television program recommender;

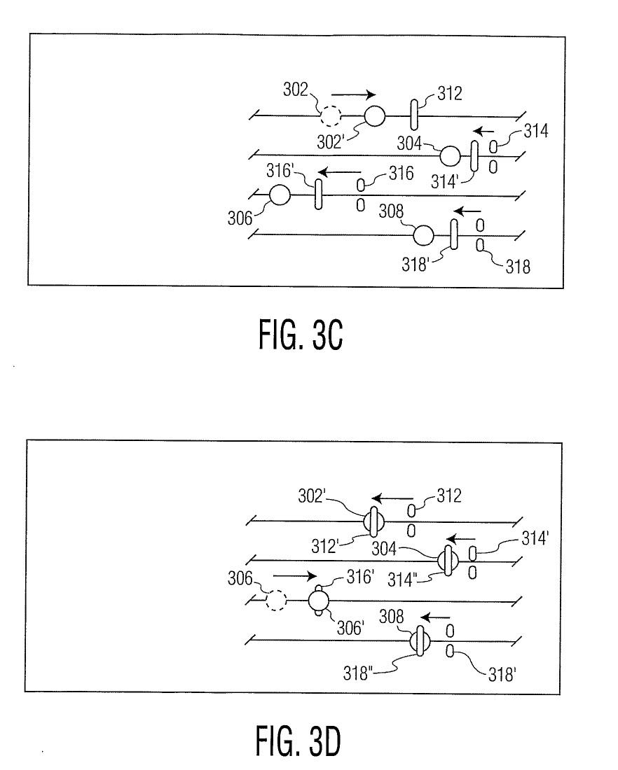

FIGS. 3A-3D show illustrations of displays showing the adjusting of the results from the television program recommender; and

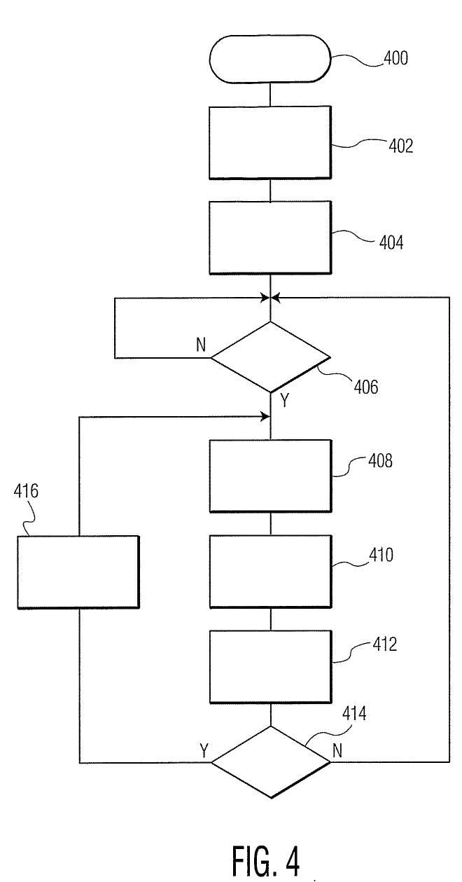

FIG. 4 shows a flowchart of the method of the invention.

FIG. 1 shows a block schematic diagram of a television receiver 100 incorporating the subject invention. The television receiver 100 receives and displays television programs originating from a source. In this example, an antenna 110 is shown as the source. However, it should be understood that the television programs may originate from any of a plurality of sources, e.g., a set-top box, a DVD player, satellite, etc. A tuner 120 is shown connected to the antenna 110 for tuning to a particular channel carrying a desired television program. The tuner 120 supplies audio signals to an audio signal processor 130 which sends corresponding sound signals to a loudspeaker 140. In addition, the tuner 120 supplies video signals to a video signal processor 150 which supplies corresponding display signals to a display 160. A controller 170 controls the operation of the tuner 120 as well as the audio and video signal processors 130 and 150. The controller 170 further provides control signals to an on-screen display (OSD) processor 180 which generates an OSD signal for displaying various graphical symbols on the display 160. This OSD signal is supplied to a video switch 190 along with the display signals from the video signal processor 150 for superimposing the graphical symbols onto the displayed images represented by the display signals.

The television receiver 100 further includes a television program recommender 200 for recommending television programs for the user. The television program recommender 200 may be connected to a database containing information concerning television programs being transmitted or to be transmitted in the future. This is shown in FIG. 1 as a connection to the tuner 120 for receiving meta-data transmitted with the television signals in the form of, for example, an electronic programming guide (EPG).

As shown in FIG. 2, the television program recommender 200 may be embodied as any computing device, such as a personal computer or workstation containing a processor 202, such as a central processing unit (CPU), and memory 204, such as RAM and/or ROM. The television program recommender 200 may also be embodied as an application specific integrated circuit (ASIC), for example, in a set-top terminal or display (not shown). In addition, the television program recommender 200 may be embodied as any available television program recommender, such as the TIVO™ system, commercially available from Tivo, Inc., of Sunnyvale, Calif., or the television program recommenders described in “Method and Apparatus for Recommending Television Programming Using Decision Trees”, U.S. patent application Ser. No. 09/466,406, filed Dec. 17, 1999; “Adaptive TV Program Recommender”, U.S. patent application Ser. No. 09/498,271, filed Feb. 4, 2000; “Three-Way Media Recommendation Method and System”, U.S. patent application Ser. No. 09/627,139, filed Jul. 27, 2000; or any combination thereof, each incorporated herein by reference, as modified herein to carry out the features and functions of the present invention.

In general, the television program recommender 200 develops profile parameters, stored in memory 204, concerning the viewing habits of a user either implicitly, i.e., by analyzing the television programs viewed by the user and developing the profile parameters, inclusive of television channel, genre, main actors/actresses, time of day, etc., or explicitly, i.e., in response to a user's answers to direct inquiries. In either case, the television program recommender 200 constructs profile parameters in various categories, and uses these profile parameters to calculate ratings for future television programs. However, as with all automated systems, the television program recommender 200 is not infallible. There is always the occasion that a television program that the user desires to watch is not recommended, or that a television program the user does not desire to watch is recommended. The subject invention is directed toward giving the user more direct and intuitive control over modifying the settings of the television program recommender 200.

In particular, for any desired television program recalled from the database (EPG), the television program recommender 200 is able to calculate a rating based on the user's profile parameters in various categories stored in the memory 204. If desired by the user, the television program recommender 200 generates a graphical display showing the program title, whether or not it is recommended for the user, as well as the profile parameters in a plurality of categories. As an example, FIG. 3A shows such a display for the movie “Terminator II”, starring Arnold Schwarzenegger. Based on the profile parameters of the user, the television program recommender 200 does not recommend this movie for viewing by the user. However, suppose, for instance, that the user finds these types of movies desirable. The question now is how the user can modify the settings of the television program recommender 200 such that it will, in the future, recommend these types of movies.

As shown in FIG. 3A, each category (e.g., channel, genre, actor, time of day) includes a profile parameter icon 302, 304, 306, and 308 showing the value of the profile parameter in that category, as well as a respective threshold target level 312,314,316 and 318 calculated for that category at which the program would be recommended. Each of the icons 302-308 are movable by the user to any other position along its respective bar, using, for example, a cursor control (not shown). If the user desires such a movie, then the user selects one of the icons, for example, channel, and moves the profile parameter icon 302 such that it is co-located with the threshold target level 312, where the profile parameter icon is shown as 302′ thereby indicating that the program is desired (recommended). The television program recommender 200, then recalculates the remaining threshold levels 314-318 based on the user's indicated desired rating, and moves the other threshold target levels (314′, 316′, 318′) such that they are also co-located with the remaining profile parameter icons 304-308, as shown in FIG. 3B.

Instead of moving only one of the profile parameter icons 302-308 to its respective threshold target level 312-318, the user may make partial adjustments to multiple profile parameter icons in two or more steps. For example, as shown in FIG. 3C, the user increases the “channel” profile parameter icon 302 to a position 302′ approximately halfway to the threshold target level 312. The television program recommender 200 then adjusts the levels of the remaining threshold target levels to 314′, 316′, 318′. Then, as shown in FIG. 3D, the user may, for example, increase the rating of the “actor” profile parameter icon to 306′ co-located with the modified threshold target level 316′, and the television program recommender 200 adjusts the other threshold target levels to 312′, 314″ and 318″ such that they are co-located with the profile parameter icons 302′, 304 and 308 in the various categories.

FIG. 4 shows a flowchart illustrating the method of the invention. From a start 400, at step 402, the television program recommender 200 generates the profile parameters for the user based on either the user's past viewing habits or the user's responses to particular inquiries. At step 404, the television program recommender 200 stores the profile parameters in memory 204. At step 406, it is checked whether the user has selected a program. If not, the flowchart loops back to step 406. If the user has selected a program, the CPU 202 calculates a rating for the selected program in step 408 based on the stored profile parameters. In addition, in step 410, the CPU 202 calculates threshold target levels in each of the categories of the profile parameters. Next, in step 412, the television program recommender 200 displays the rating, the threshold target levels and the profile parameters. At step 414, it is checked whether the user has changed any of the profile parameters. If not, the flowchart loops back to the step 406. If so, at step 416, the changed profile parameters are stored in memory 204, and the flowchart loops back to step 408.

The user is thus able to adjust the profile parameters of the television program recommender 200 such that it will now recommend at least the types of programs for which the user has indicated a desire to watch.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims. In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method for controlling a program recommender (200), comprising the steps of:
generating (402) and storing (404) profile parameters in various categories concerning a user's likes and dislikes in programming;
calculating (408) a rating for a selected program based on said profile parameters in said various categories;
determining (408) whether or not said selected program is recommended;
calculating a threshold score (410) in each of said various categories above which said selected program would be recommended;
displaying (412) whether or not said selected program is recommended, said profile parameters and said threshold scores;
enabling said user to adjust at least one of said profile parameters (414) with respect to a respective at least one of said threshold scores in order to change whether said selected program and other similar programs are or are not recommended; and
recalculating said rating (408) and said threshold scores (410) in accordance with said at least one adjusted profile parameter.

2. The method as claimed in claim 1, wherein said profile parameters and said threshold scores are displayed as respective icons (302-308, 312-318) on a bar chart-type graph.

3. The method as claimed in claim 2, wherein profile parameter icons (302-308) are moveable by said user, the movement of the profile parameter icons (302-308) representing new values for each of said profile parameters (302-308).

4. An arrangement for controlling a program recommender, comprising:
means for generating (202) and storing profile parameters in various categories concerning a user's likes and dislikes in programming;
means for calculating (202) a rating for a selected program based on said profile parameter in each of said various categories;
means for determining (202) whether or not said selected program is recommended;
means for calculating (202) a threshold score in each of said various categories above which said selected program would be recommended;
means for displaying (200, 180, 190, 160) whether or not said selected program is recommended, said profile parameters and said threshold scores;
means for enabling (170, 200, 180, 190, 160) said user to adjust at least one of said profile parameters with respect to a respective at least one of said threshold scores in order to change whether said selected program and other similar programs are or are not recommended; and
means for recalculating (202) said rating and said threshold scores in accordance with said at least one adjusted profile parameter.

5. The arrangement as claimed in claim 4, wherein said displaying means (200, 180, 190, 160) displays said profile parameters and said threshold scores as respective icons (302-308, 312-318) on a bar chart-type graph.

6. The arrangement as claimed in claim 5, wherein said arrangement further comprises means for moving (170) said profile parameter icons (302-308) by said user, the movement of the profile parameter icons (302-308) representing new values for the profile parameters for said profile parameter icons (302-308).
